(19) United States
(12) Patent Application Publication
(10) Pub. No.: US 2007/0291623 A1
(43) Pub. Date: Dec. 20, 2007

(54) CANTILEVER WITH CONTROL OF VERTICAL AND LATERAL POSITION OF CONTACT PROBE TIP

(75) Inventors: Nickolai Belov, Los Gatos, CA (US); Zebulah Nathan Rapp, Mountain View, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/553,408

(22) Filed: Oct. 26, 2006

Related U.S. Application Data
(60) Provisional application No. 60/813,959, filed on Jun. 15, 2006.

(51) Int. Cl. G11B 7/00; G11B 9/00

(52) U.S. Cl. 369/126; 365/185.19; 365/151; 369/100

(57) ABSTRACT

An embodiment of a probe storage device in accordance with the present invention can include an electrostatic actuator for controlling the z-position of a cantilever having a contact probe tip extending therefrom. The electrostatic actuator can comprise two electrodes: the cantilever and a conductive portion in overlapping proximity to the cantilever. By controlling the z-position of the cantilever, the contact probe tip can be selectively engaged and disengaged from a surface of a memory media, thereby allowing the contact probe to selectively read from and/or write to the memory media.

### CLAIM TO PRIORITY

This application claims benefit to the following U.S. Provisional Application:

U.S. Provisional Patent Application No. 60/813,959 entitled CANTILEVER WITH CONTROL OF VERTICAL AND LATERAL POSITION OF A CONTACT PROBE TIP, by Nickolai Belov et al., filed Jun. 15, 2006, Attorney Docket No. NANO-01044US0.

### CROSS-REFERENCE TO RELATED PATENT APPLICATIONS

This application incorporates by reference all of the following co-pending applications and the following issued patents:

U.S. patent application Ser. No. 11/177,550, entitled “Media for Writing Highly Resolved Domains,” by Yevgeny Vasilievich Anoikin et al., filed Jul. 8, 2005, Attorney Docket No. NANO-01032US1;

U.S. patent application Ser. No. 11/177,639, entitled “Patterned Media for a High Density Data Storage Device,” by Zhaohui Fan et al., filed Jul. 8, 2005, Attorney Docket No. NANO-01033US0;

U.S. patent application Ser. No. 11/177,062, entitled “Method for Forming Patterned Media for a High Density Data Storage Device,” by Zhaouhi Fann, filed Jul. 8, 2005, Attorney Docket No. NANO-01033US1;

U.S. patent application Ser. No. 11/177,599, entitled “High Density Data Storage Devices with Read/Write Probes with Hollow or Reinforced Tips,” by Nickolai Belov, filed Jul. 8, 2005, Attorney Docket No. NANO-01034US0;

U.S. patent application Ser. No. 11/177,731, entitled “Methods for Forming High Density Data Storage Devices with Read/Write Probes with Hollow or Reinforced Tips,” by Nickolai Belov, filed Jul. 8, 2005, Attorney Docket No. NANO-01034US1.

U.S. patent application Ser. No. 11/177,642, entitled “High Density Data Storage Devices with Polarity-Dependent Memory Switching Media,” by Donald E. Adams, et al., filed Jul. 8, 2005, Attorney Docket No. NANO-01035US0;

U.S. patent application Ser. No. 11/178,060, entitled “Methods for Writing and Reading in a Polarity-Dependent Memory Switching Media,” Donald E. Adams, filed Jul. 8, 2005, Attorney Docket No. NANO-01035US1;

U.S. patent application Ser. No. 11/178,061, entitled “High Density Data Storage Devices with a Lubricant Layer Comprised of a Field of Polymer Chains,” by Yevgeny Vasilievich Anoikin et al., filed Jul. 8, 2005, Attorney Docket No. NANO-01036US0;

U.S. patent application Ser. No. 11/004,153, entitled “Methods for Writing and Reading Highly Resolved Domains for High Density Data Storage,” by Thomas F. Rust et al., filed Dec. 3, 2004, Attorney Docket No. NANO-01024US1;

U.S. patent application Ser. No. 11/003,953, entitled “Systems for Writing and Reading Highly Resolved Domains for High Density Data Storage,” by Thomas F. Rust, filed Dec. 3, 2004, Attorney Docket No. NANO-01024US2;

U.S. patent application Ser. No. 11/004,709, entitled “Methods for Erasing Bit Cells in a High Density Data Storage Device,” by Thomas F. Rust et al., filed Dec. 3, 2004, Attorney Docket No. NANO-01031US0;

U.S. patent application Ser. No. 11/003,541, entitled “High Density Data Storage Device Having Erasable Bit Cells,” by Thomas F. Rust, et al., filed Dec. 3, 2004, Attorney Docket No. NANO-01031US1;

U.S. patent application Ser. No. 11/003,955, entitled “Methods for Erasing Bit Cells in a High Density Data Storage Device,” by Thomas F. Rust et al., filed Dec. 3, 2004, Attorney Docket No. NANO-01031US2;

U.S. patent application Ser. No. 10/684,661, entitled “Atomic Probes and Media for high Density Data Storage,” by Thomas F. Rust et al., filed Oct. 14, 2003, Attorney Docket No. NANO-01014US1;

U.S. patent application Ser. No. 11/321,136, entitled “Atomic Probes and Media for High Density Data Storage,” by Thomas F. Rust, et al., filed Dec. 29, 2005, Attorney Docket No. NANO-01014US2;

U.S. patent application Ser. No. 10/684,760, entitled “Fault Tolerant Micro-Electro Mechanical Actuators,” Thomas F. Rust et al, filed Oct. 14, 2003, Attorney Docket No. NANO-01015US1;

U.S. patent application Ser. No. 09/465,592, entitled “Molecular Memory Medium and Molecular Memory Integrated Circuit,” by Joanne P. Culver, et al., filed Dec. 17, 1999, Attorney Docket No. NANO-01000US0;

U.S. Pat. No. 6,985,377, entitled “Phase Change Media for High Density Data Storage,” Attorney Docket No. NANO-019US1, issued Jan. 10, 2006, to Thomas F. Rust et al.;

U.S. Pat. No. 6,982,898, entitled “Molecular Memory Integrated Circuit Utilizing Non-Vibrating Cantilevers,” Attorney Docket No. NANO-1011US1, issued Jan. 3, 2006, to Thomas F. Rust et al;

U.S. Pat. No. 5,435,970, entitled “Molecular Memory Medium and Molecular Memory Disk Drive for Storing Information Using a Tunnelling Probe,” issued Sep. 26, 1995 to Thomas F. Rust, et al.

### COPYRIGHT NOTICE

A portion of the disclosure of this patent document contains material which is subject to copyright protection. The copy right owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates to high density data storage using molecular memory integrated circuits.

### BACKGROUND

Software developers continue to develop steadily more data intensive products, such as evermore sophisticated, and graphic intensive applications and operating systems (OS). Each generation of application or OS always seems to earn the derisive label in computing circles of being “a memory hot.” Higher capacity data storage, both volatile and non-volatile, has been in persistent demand for storing code for such applications. Add to this need for capacity, the confluence of personal computing and consumer electronics in the form of personal MP3 players, such as the iPod, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to TiVo® use hard disk drives. While hard disk drives store large amounts of data, they consume a great deal of power, require long access times, and require “spin-up” time on power-up. FLASH memory is a more readily accessible from of data storage and a solid-state solution to the lag time and high power consumption problems inherent in hard disk drives. Like hard disk derives, FLASH memory can store data in a non-volatile fashion, but the cost per megabyte is dramatically higher than the cost per megabyte of an equivalent amount of space on a hard disk drive, and is therefore sparingly used.

Phase change media are used in the data storage industry as an alternative to traditional recording devices such as magnetic recorders (tape recorders and hard disk drives) and solid state transistors (EEPROM and FLASH). CD-RW data storage discs and recording drives use phase change technology to enable write-erase capability on a compact disc-style media format. CD-RWs take advantage of changes in optical properties (e.g., reflectivity) when phase change material is heated to induce a phase change from a crystalline state to an amorphous state. A “bit” is read when the phase change material subsequently passes under a laser, the reflection of which is dependent on the optical properties of the material. Unfortunately, current technology is limited by the wavelength of the laser, and does not enable the very high densities required for use in today's high capacity portable electronics and tomorrow's next generation technology such as systems-on-a-chip and micro-electric mechanical systems (MEMS). Consequently, there is a need for solutions which permit higher density data storage.

### BRIEF DESCRIPTION OF THE DRAWINGS

Further details of the present invention are explained with the help of the attached drawings in which:

FIGS. 1A and 1B illustrate displacement of a contact probe tip due to friction force at the interface with the media.

FIGS. 1C and 1D illustrate displacement of contact probe tip having a smaller height relative to the contact probe tip of FIGS. 1A and 1B, the displacement occurring due to friction force at the interface with the media.

FIGS. 2A-2C illustrate an effect of thermal oxidation on a sharpness of the contact probe tip.

FIGS. 3A and 3B are plan views of a straight bar shaped contact probe cantilever and a chevron shaped contact probe cantilever.

FIGS. 4A and 4B are plan and cross-sectional views, respectively, of an embodiment of an electrostatic actuator with one stop for use with a cantilever having a contact probe tip in accordance with the present invention.

FIG. 4C is a cross-sectional view of the cantilever of FIGS. 4A and 4B deflected by electrostatic actuation.

FIG. 5A is plan view of an embodiment of an electrostatic actuator with two stops for use with a cantilever having a contact probe tip in accordance with the present invention.

FIGS. 5B and 5C are cross-sectional views of the electrostatic actuator of FIG. 5A.

FIG. 6A is a plan view of a straight bar shaped contact probe cantilever.

FIG. 6B is a cross-sectional view of the same cantilever in a cross-section along its longitudinal axis.

FIGS. 6C, 6D and 6E are cross-sectional views of a straight bar shaped contact probe cantilever in a cross-section perpendicular to its longitudinal axis.

FIGS. 7A, 7B, and 7C are cross-sectional views of contact probe cantilever with vertical electrostatic actuator and stops before etching of sacrificial layers.

FIGS. 8A and 8B are plan views of embodiments of cantilevers in accordance with the present invention.

FIGS. 9A and 9B are plan and cross-sectional views, respectively, of an embodiment of an electrostatic actuator for controlling lateral position of a cantilever having a contact probe tip in accordance with the present invention.

FIG. 9C is a cross-sectional view of a cantilever with AFM tip deflected horizontally in the longitudinal direction of the beam.

FIG. 9D is a plan view of an electrostatic actuator utilizing comb-structure for controlling lateral position of a cantilever having a contact probe tip in accordance with the present invention.

### DETAILED DESCRIPTION

Probe storage devices enabling higher density data storage relative to current technology can include cantilevers with contact probe tips as components. Such probe storage devices typically use two parallel plates. A first plate includes the cantilevers with contact probe tips extending therefrom for use as read-write heads and a second, complementary, plate includes memory media for storing data. At least one of the plates can be moved with respect to the other plate in a lateral X-Y plane while maintaining satisfactory control of the Z-spacing between the plates. Motion of the plates with respect to each other allows scanning of the memory media by the contact probe tips and data transfer between the contact probe tips and the memory media.

In some probe storage devices, for example utilizing phase change materials in a stack of the memory media, both mechanical and electrical contact between the contact probe tips and the memory media enables data transfer. In order to write data to the memory media, it is necessary to pass current through the contact probe tips and the phase change material to generate heat sufficient to cause a phase-change in some portion of the phase change material (said portion also referred to herein as a memory cell). Electrical resistance of the memory media can vary depending on the parameters of the write pulse, and therefore can represent data. Reading data from the memory media requires a circuit with an output sensitive to the resistance of the memory cell. An example of one such circuit is a resistive divider. Both mechanical and electrical contact between the contact probe tip and the memory media may also enable data transfer where some other memory media is used, for example memory media employing polarity-dependent memory.

A data transfer rate of a contact probe tip is determined in part by the scanning speed of the contact probe tip, a distance between memory cells, and a number of bits stored in a memory cell. For example, if a scanning speed of a contact probe tip is 3.2 cm/s, the distance between neighboring memory cells is 32 nm, and each cell contains 2 bits, then a raw data rate per contact probe tip is 2 megabits per second. However, the effective data transfer rate can be lower because of two factors: (a) some percentage of the memory cells may be used for error correction, and to store navigation and/or other information that is not transferred to the user, and (b) although the movable plates move (relative to one another) with approximately constant speed through a central portion of the scan area of the memory media, motion may slow down, stop, and reverse in direction when reading data at the ends of the scan area (such portions of the scan area can be referred to as turnaround areas). If a contact probe tip performs read-write operations in the turnaround areas the data transfer rate in these areas is expected to be lower than the data transfer rate in central portion of the scan area where contact probe tip moves with a relatively constant speed.

Data intensive applications (e.g., recording and/or playing video) can require data transfer rates as high as 10-20 megabytes per second. In order to achieve this range of data transfer rates, multiple contact probe tips can be employed to transfer data to and from the memory media. For example, if the effective data transfer rate per contact probe tip is 1.25 megabit per second and the required data transfer rate is 160 megabits per second (20 megabytes at 8 bits per byte), then at least 128 contact probe tips can be used simultaneously for data transfer.

The contact probe tips should be positioned over the same tracks during writing of data and reading of the written data to read data without errors. Factors such as temperature can cause shifting of a contact probe tip with respect to the data tracks on the memory media and with respect to other contact probe tips. Fine position control of the contact probe tips can compensate for shifting by enabling adjustment of the lateral position of the contact probe tips at least in cross-track direction. Position adjustment in the down-track direction is less applicable because drift can be effectively handled by data processing means as timing error.

Fabrication of Low-Height Contact Probe Tips

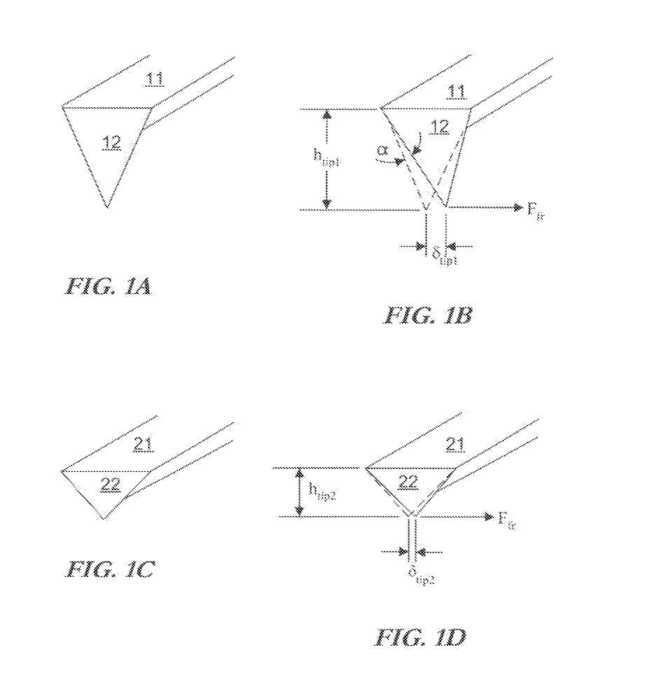

Random movement of a contact probe tip with respect to the data track due to friction force at the contact probe tip and memory media interface is a factor that may not be easily compensated for by fine position control. Several parameters can affect the random movement of the contact probe tip due to friction force, including the coefficient of friction between the tip and the memory media, the natural frequency of the cantilever, and the height of the contact probe tip. FIGS. 1A-1D illustrate the affect of the height of a contact probe tip 12,22 on random movement due to friction force. A contact probe tip 22 having a smaller height (as shown in FIGS. 1C and 1D) exhibits less positional displacement for a similar value of friction force as a contact probe tip 12 having a larger height. FIG. 1A shows a cantilever 11 with a “tall” contact probe tip 12 not loaded with a friction force. FIG. 1B shows the same contact probe tip 12 loaded with a friction force F_{fr}. The friction force creates a torque T proportional to the product of the contact probe tip height hₜᵢₚ₁ (T=F_{fr}hₜᵢₚ₁). The torque T torque causes some twisting of the cantilever 11. The angle of twisting α is proportional to the applied torque T. The resulting displacement δₜᵢₚ₁ of the contact probe tip 12 is proportional to the product of the angle of twisting α and the tip height hₜᵢₚ₁ (δₜᵢₚ₁≈hₜᵢₚ₁ α). The lateral displacement of the contact probe tip 12 is therefore proportional to a square of the contact probe tip height hₜᵢₚ₁(δₜᵢₚ₁≈F_{fr}h²ₜᵢₚ₁).

FIG. 1C shows a cantilever 21 with a “short” contact probe tip 22 not loaded by a friction force. FIG. 1D shows the same contact probe tip 22 loaded with the friction force F_{fr}. The height hₜᵢₚ₂ of the contact probe tip 22 is smaller than that of the contact probe tip 22 shown in FIG. 1A, and the torque T created by the friction force F_{fr} and the twisting angle α of the cantilever 21 is smaller. The lateral displacement δₜᵢₚ₂ of the “short” contact probe tip 22 is smaller than the lateral displacement δₜᵢₚ of the “tall” contact probe tip 12. The difference in lateral displacement is roughly proportional to the squared decrease of the contact probe tip height. Thus, decreasing the tip height can be desirable and can decrease random movement by decreasing lateral displacement of the contact probe tip due to friction force at a contact probe tip and memory media.

Short contact probe tips can be desirable in probe storage devices due to the smaller torque that the cantilever 21 is subjected to when scanning the surface of the memory media. Reducing the lateral movement of the contact probe tips 22 can improve control tip position by reducing tip displacement, thereby increasing the tracking precision of the device. Short contact probe tips can be fabricated through a series of standard semiconductor processes.

For example, in an embodiment, a contact probe tip having a desirably short height can be formed in a series of process steps. A thin silicon dioxide layer can be formed on a substrate. Preferably, thermal oxidation is used to form the layer. A thermal silicon dioxide (also referred to herein as a thermal oxide) layer can be as thin or as thick as needed (500 A to 1 μm for example). A thin silicon nitride film can be deposited over the thermal oxide. The thermal oxide can serve as an adhesion layer for silicon nitride. For example, low pressure chemical vapor deposition (LPCVD) silicon nitride or plasma enhanced chemical vapor deposition (PECVD) silicon nitride can be preferred to withstand high process temperatures. The silicon nitride film is a masking layer for later processing steps. A thickness of the silicon nitride film is determined so as to act as a barrier during subsequent thermal oxidation step(s) and so as to protect the underlying silicon substrate from etching during the dry silicon etch. For example, typically LPCVD nitride film can be chosen in the range of 500 A to 3500 A. Both the silicon dioxide and silicon nitride layers are sacrificial in the tip forming process, but they can also be incorporated into the probe storage device.

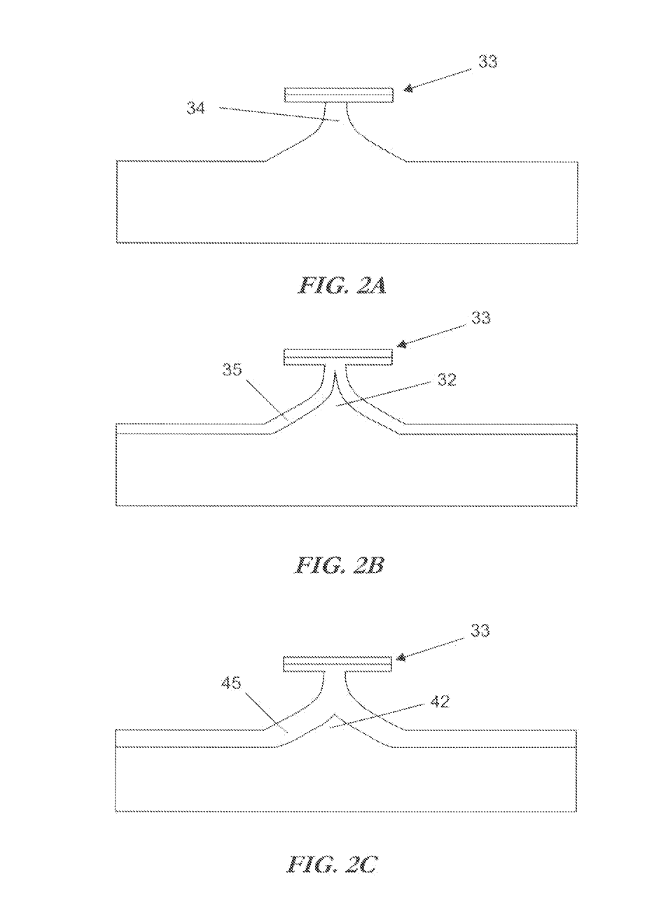

Photolithography can define areas where contact probe tips will be formed. A tip area can consist of a small square, polygon or circle are protected by a dielectric stack of silicon nitride and silicon dioxide surrounded by an open area. Linear dimensions of the small tip area protected by many typical photolithographic processes can range from 0.2 μm to 5 μm. Silicon nitride and silicon dioxide are both selectively etched away in the open areas, leaving silicon exposed. Etching of silicon nitride and thermal oxide layers is followed by a dry silicon etching step. Dry anisotropic etching of both dielectric layers and silicon provides preferred control for etching small features. Etching of silicon undercuts the edges of tip areas. The resulting structure is mushroom-like, with a silicon leg 34 and a dielectric stack 33 as a cap as shown in FIG. 2A. Thermal oxide 35,45 is then re-grown, as shown in FIGS. 2B and 2C. During the thermal oxidation, the silicon leg 34 of the mushroom structures is oxidized, forming a silicon tip 32,42 beneath the oxide. The thermal oxide 35,45 is preferably thick enough to pinch off the silicon near the dielectric stack 33 and disconnect the silicon leg 34 between the dielectric stack 33 and the silicon tip 32,42. The dielectric stack 33 causes oxidation to occur from the sides, creating sharper tips 32,42. A thickness of the thermal oxide affects tip shape. The thermal oxide 35,45 is then stripped using a wet etch process (e.g. buffered oxide etch (BOE)). The dielectric stack 33 is also removed during this step. The silicon nitride layer can be removed completely at this step using a wet process (e.g. etching in hot phosphoric acid). A final layer of thermal oxide can be grown if oxide tips are required. A metal coating can be deposited over the tip to make the tips conductive.

To achieve high resolution and lower random movements of a contact probe tip due to friction force (as described above), it can be desirable to form a silicon tip shape that is short and sharp. Embodiments of methods for forming a probe storage device in accordance with the present invention include controlling several factors during fabrication of contact probe tips. In an embodiment, tip height can be controlled by reducing the tip pattern size defined during photolithography. A pattern having smaller feature sizes can result in an smaller overall tip height, for a given etch process. Tip pattern size is constrained by the capability of the photolithographic tool and photolithographic process including pattern resolution and repeatability. Further, tip pattern shapes can affect tip height. At larger tip pattern sizes, for a given width dimension, tip height will be greatest with a shape having a larger area, such as a square pattern as compared with a polygon or circle, for example. As width dimension decreases the differences between, for example, a square, a polygon, and a circle become negligible due to decreased resolution at small feature sizes.

Tip height can also be affected by the thermal oxidation after the dry silicon etching step. As can be seen in FIG. 2C, a thick oxide 45 can decrease tip height, but at the cost of increased tip radius or poor “sharpness.” Tips with large radius of curvature are considered “dull,” while tips with small radius of curvature are “sharp.” Thick oxides (typically thicker than 1 um) can be used to create short tips with large radius of curvature. Thin oxides (typically thinner than 1 um) can be used to create taller tips with small radius of curvature. After tips are formed, their height can be reduced using subsequent thin thermal oxidations (<0.5 um) and oxide etching (wet). This is important because each set of oxidation and oxide etching steps reduces tip height while keeping the tip radius relatively constant. Final tip metallization can further influence tip sharpness. A thick metal coating can increase tip radius of curvature. It is better to form a sharp silicon tip during the process because subsequent processing (final oxidation and/or metallization) can be used to increase the tip radius to reach requirements for probe storage device. Tip height can be controlled by tip pattern size and subsequent oxidations.

Actuator for Control of Z-position of Contact Probe Tips

In probe storage device architectures employing a large number of contact probe tips, it can be advantageous to use only a small portion of the contact probe tips for data transfer at any given moment of time. A reduced portion of “active” contact probe tips can significantly reduce a number of electrical interconnects needed for the probe storage device architecture. For example, a probe storage device with a target capacity of 16 gigabytes with 2 bits stored in each of the memory cells and a hypothetical 25% formatting overhead requires N=(16×1024×1024×1024×8)/2/(1−0.25)≈9.16·10¹⁰ memory cells. If a cell size is 32 nm, the size of the area used to store this amount of data can be evaluated as approximately 93.2 mm². If the plates have a ±75 μm range of motion relative to one another, approximately 4,170 read-write heads can access the surface of the memory media. However, only a smaller number of contact probe tips are actually used for data transfer (e.g., 128 contact probe tips for 20 megabytes per second data transfer rate).

Further, contact probe tips can wear due to friction at the interface between the contact probe tips and the memory media, and due to material transfer processes associated with electrical current flow. Wearing of the contact probe tips can be decreased by disengaging non-active contact probe tips from the surface of the memory media. Disengagement can also decrease the overall friction force between the contact probe tips and the memory media, and consequently can decrease positional errors associated with random movement caused by friction forces acting on the movable parts of the probe storage device. Control of z-positioning of the contact probe tips with respect to the memory media can enable both engaging and disengaging contact probe tips with the memory media.

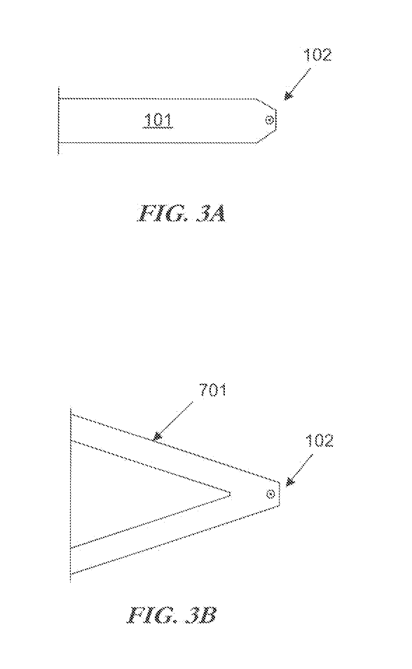

FIG. 3A illustrates a straight cantilever 101 for use in a probe storage device. FIG. 3B illustrates a chevron type, dual-leg cantilever 710 for use in a probe storage device. A contact probe tip 102 extends from near a free end of the cantilever 101. The length, width, and thickness of a cantilever 101 can influence the bending stiffness of the cantilever 101 (i.e. the amount of normal-to-cantilever plane force applied at the free end of cantilever to cause a unit deflection). Where the contact probe tip 102 is located approximately near the end of the cantilever 101, a normal force applied to the contact probe tip 102 will cause about substantially the same displacement as the normal force applied to the end of the cantilever 101. Thus, the force applied to the end of cantilever 101 is referred to herein as a tip force. The stiffness of a cantilever 101 is proportional to its width, and the cube of its thickness, as well as the Young's modulus of the material of which its composed. The stiffness of the cantilever 101 is further inversely proportional to the cube of its length.

A gap between the surface of a memory media and a platform from which a cantilever 101 extends can be closed due to bending of the cantilever 101 toward the memory media. Bending of the cantilever 101 is preferably large enough to urge the contact probe tip 102 against the memory media with a force sufficient for creating stable electrical contact. Sufficient force depends on multiple factors including physical properties (e.g. electrical conductivity, Young's modulus) of the materials used for forming the contact probe tip 102, the radius of curvature of the contact probe tip 102, surface properties (e.g., roughness, microstructure) of the contact probe tip, an overcoat material applied to the memory media surface and/or the surface of a structure having memory media, and physical properties of the materials forming the memory media stack. In some applications, the tip force at the interface of the contact probe tip 102 and memory media should be in the range of hundreds of nanoNewtons in order to establish a reliable electrical contact between the contact probe tip 102 and the memory media.

Z-actuators used for disengaging (or engaging) contact probe tips with the memory media should be capable of generating forces that exceed the force urging the contact probe tip against the memory media (or away from the memory media). Several actuation techniques can be applied for control of the z-position of the cantilevers. In an embodiment of a device in accordance with the present invention, a cantilever can include z-position control by thermal actuation. In such an embodiment, a cantilever can be formed of a stack of materials having different thermal expansion coefficients. One or more of the layers of the stack of materials is conductive or semi-conductive. If layers nearer the surface of the cantilever from which the contact probe tip extends have a higher thermal expansion coefficient than layers generally farther from the contact probe tip, then heating the multi-layer cantilever can cause bending of the cantilever so that the contact probe tip is disengaged from the media stack. This design of thermal actuator for control of vertical position of the cantilevers and contact probe tips can require that initially the cantilevers be bent toward the memory media and pressed against the surface of the memory media with a force for establishing electrical contact. In an alternative embodiment, the cantilevers can be disengaged from the media stack when not actuated. If layers nearer the surface of the cantilever from which the contact probe tip extends have a lower thermal expansion coefficient than layers generally farther from the contact probe tip then heating the multi-layer cantilever can cause bending of the cantilever so that the contact probe tip engages the memory media.

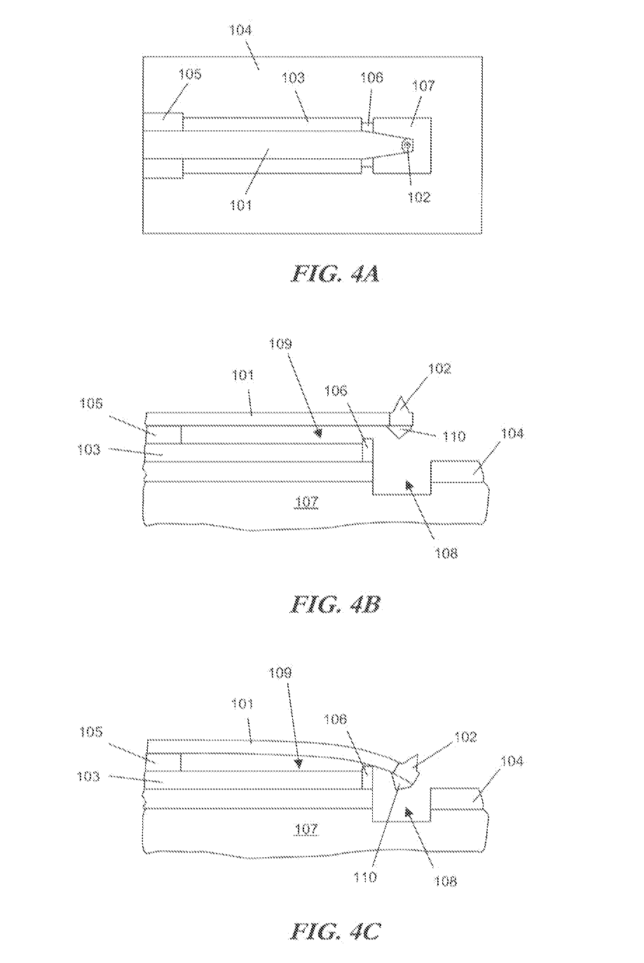

In still another embodiment of a device in accordance with the present invention, a cantilever can include z-position control by electrostatic actuation. FIG. 4A is a plan view and FIGS. 4B and 4C are cross-sectional views of an exemplary structure of a cantilever 101 having a contact probe tip 102 extending from the cantilever 101, and an electrostatic actuator for z-position control. The cantilever 101 with contact probe tip 102 and the electrostatic actuator are formed on a silicon substrate 107 covered by a field dielectric layer 104. The electrostatic actuator is formed by the conductive cantilever 101, which serves as a first electrode, and a metal layer 103, which serves as a second electrode (also referred to herein as an actuator electrode) of the electrostatic actuator. Electrostatic force is generated by applying voltage between the cantilever 101 and the actuator electrode 103. Electrodes 101,103 of the electrostatic actuator are separated by an air-gap 109 and by a dielectric layer 105. To ensure current flow at the interface of the contact probe tip 102 and the memory media, during actuation it is possible to change the electrical potential of the actuator electrode 103 with respect to the cantilever 101 without changing the electrical potential of the cantilever 101. In order to prevent sticking between the cantilever 101 and the actuator electrode 103, at least one stop 106 is formed beneath the cantilever 101. A height of the stop 106 is, preferably, smaller than the depth of the air-gap 109 between the cantilever 101 and the actuator electrode 103 provided by the isolation dielectric 105. The stop 106 can be formed using the same isolation dielectric deposited directly on the field dielectric layer 104. The air gap 109 is formed by etching of a sacrificial layer. Different materials can be used to form a sacrificial layer. For example, metal, poly-silicon and dielectric layers as PECVD oxide and LPCVD nitride and combination of these materials can serve as a sacrificial layer.

Fabrication of the contact probe tip 102 located at the end of the cantilever 101 can be accomplished using process steps described in the above section incorporated into a process flow suitable for fabrication of a structure as shown in FIGS. 3A-3C or a structure as shown in FIGS. 4A-4C. When formed, the contact probe tip 102 is typically connected to the silicon substrate 107. At least one etching step is used in order to release the contact probe tip 102. A cavity 108 is formed under the tip 102 as a result of the at least one etching step. Contact probe tip release can be controlled by designed of the etch mask, a type of etching agent, a recipe, etching time, and number of etching steps. A silicon structure 110 reinforcing the contact probe tip 102 can be retained at the end of an etching process. A size and shape of the reinforcing structure 110 can be controlled by the pattern used for etching (i.e., the etch mask), type of etching agent, recipe, etching time, and number of etching steps. For example, a contact probe tip 102 with a reinforcing structure 110 can be formed by a reactive ion etching (RIE) step followed by either anisotropic etching or isotropic etching. The RIE step enables profiles having substantially vertical sidewalls. A further etching step allows undercutting of the contact probe tip 102 and forms a reinforcing structure 110 under the contact probe tip 102.

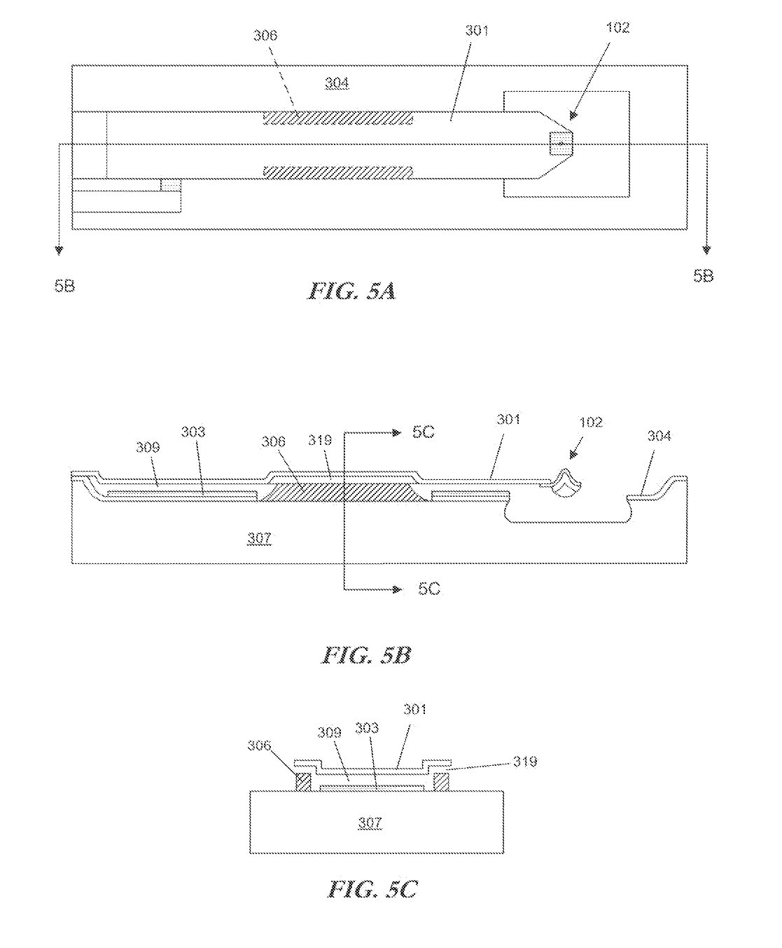

FIG. 5A is plan view of another embodiment of an electrostatic actuator with two stops 306 for use with a cantilever 301 having a contact probe tip 102 in accordance with the present invention. FIG. 5B is a cross-sectional view of the same structure parallel to the longitudinal axis of cantilever 301. FIG. 5C is a cross-sectional view of the same structure perpendicular to the longitudinal axis of the cantilever 301 and to the stops 306. As shown in FIGS. 5A-5C, the actuator structure has two features: (a) the contact area between the cantilever 301 and the stops 306 is much smaller than surface area of the cantilever 301 and (b) the depth of the gap 319 between the cantilever 301 and the stops 306 is smaller than depth of the gap 309 between the cantilever 301 and the actuator electrode 303 located under the cantilever 301. These features allow: (a) protection of the cantilever 301 from mechanical and electrical contact with the actuator electrode 303 and (b) protection of the structure from stiction. Mechanical and electrical contact between the cantilever 301 and the actuator electrode 303 is undesirable because it can cause both short electrical connection between electrodes 301, 303 in the electrostatic actuator and sticking of the cantilever 301 to the actuator electrode 303. Where a contact area between the cantilever 301 and the stops 306 is small, restoring force due to built-in stress in the cantilever 301 can be enough to overcome attraction forces acting at the interface between the cantilever 301 and the stops 306 when they are in a mechanical contact.

If a metal cantilever 301 is deposited on top of a sacrificial layer, which has the same thickness over the stops 306 as over the actuator electrode 303, then after release the cantilever 301 will have travel distance to stops 306 approximately the same travel distance to the actuator electrode 303. As a result, stops 306 will not prevent undesirable contact between the cantilever 301 and the actuator electrode 303. Therefore, it is desirable to increase the thickness of the sacrificial layer between the cantilever 301 and the actuator electrode 303 bigger than thickness of a sacrificial layer between the cantilever 301 and the stops 306.

The stops 306 are shown in FIG. 5A-5C as structures having a top surface above the actuator electrode 303. Alternatively, the stops 306 can have a top surface at the same level, above or below the plane of actuator electrode 303. The thickness of a sacrificial layer between the cantilever 301 and the stops 306 should be smaller than the thickness of a sacrificial layer between the cantilever 301 and the actuator electrode 303.

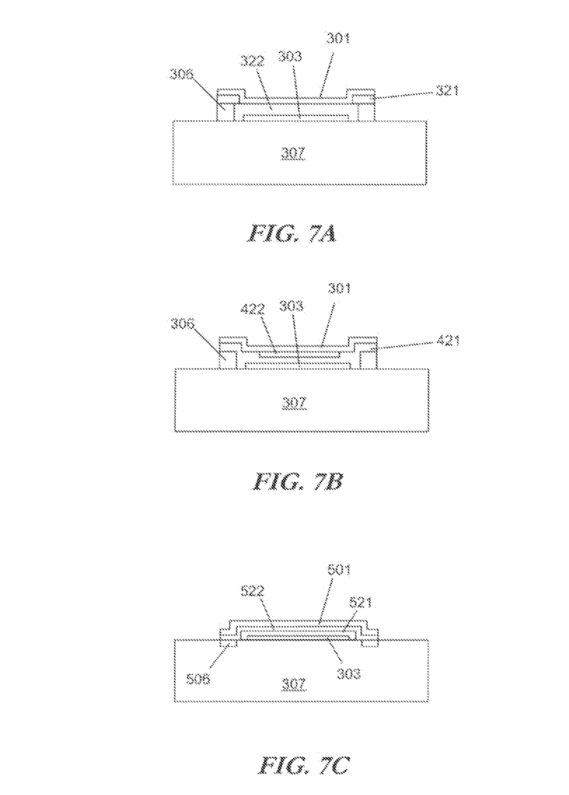

Several options can be used in order to make thickness of sacrificial layer on top of the stops 306 smaller than thickness of sacrificial layer on top of the actuator electrode 303. The first option is related to using two different stacks of sacrificial materials. FIG. 7A illustrates a stack of materials formed in the process of fabrication of cantilevers 301 with contact probe tips (not shown). One stack of sacrificial materials 321 is formed between the cantilever 301 and the stops 306 and another stack of sacrificial materials 322 is formed between the cantilever 301 and the actuator electrode 303. Thickness of stack of sacrificial materials 321 between the cantilever 301 and stops 306 is smaller than thickness of stack of sacrificial materials 322 between the cantilever 301 and actuator electrode 303. After cantilever release, when a voltage drop is applied between the cantilever 301 and bottom actuator electrode 303, the cantilever 301 is attracted to the actuator electrode 303 and deflects toward it. Distance between the cantilever and the stops 306 is smaller than the distance between the cantilever 301 and the actuator electrode 303. Therefore, cantilever 301 will be stopped by stops 306 in its motion toward the actuator electrode 303 and will not contact the actuator electrode 303. For example, sacrificial layer on top of stops 306 can be formed using a thin thermal oxide protected by a layer of LPCVD nitride while sacrificial layer between the cantilever 301 and the actuator electrode 303 can be formed using PECVD oxide. Thickness of the PECVD oxide layer can be bigger than at least thickness of the thermal oxide layer grown on top of stops 306. Preferably, thickness of the PECVD oxide layer is bigger than combined thickness of the LPCVD nitride layer and the thermal oxide layer deposited on top of stops 306. This method requires removing PECVD oxide from the top surface of the stops 306 before cantilever material deposition.

Another example of different sacrificial layers deposited on top of stops 306 and on top of actuator electrode 303 is illustrated in FIG. 7B. A stack of sacrificial layers 421 is deposited both on top of stops 306 and on top of actuator electrode 303. Stack of sacrificial layers 421 contains at least one sacrificial layer. At least one more sacrificial layer 422 is deposited on top of the actuator electrode 303. Etching of sacrificial layers 421 and 422 creates a structure, which has a gap between the cantilever 301 and stops 306 smaller than the gap between the cantilever 301 and the actuator electrode 303. For example, structure shown in FIG. 7B can be formed by using a layer 421 of PECVD oxide both on top of stops 306 and on top of actuator electrode 303 and, in addition, a sacrificial metal layer 422 can be deposited on top of actuator electrode. Aluminum, titanium, tungsten and other metals can be used as a sacrificial metal. Thickness of the sacrificial metal determines the different in the depth of the air gap between the cantilever 301 and stops 306 and depth of the air gap between cantilever 301 and actuator electrode 303. Thickness of the PECVD oxide layer can be, preferably, in the range of 200 nm to 2000 nm. Thickness of the sacrificial metal layer can be, preferably, in the range of 10 nm to 1000 nm.

An alternative embodiment of stops to prevent stiction between cantilever and actuation electrode is shown in FIG. 7C. FIg. 7C is a cross-sectional view of a cantilever 501, actuation electrode 303 and stops 506 prior to removal of sacrificial layers 521 and 522. Each of sacrificial layers 521 and 522 can be represented by only one layer or multiple layers. The sacrificial layer 521 is deposited on top of actuator electrode 303. The stack of sacrificial layers 521 contains at least one sacrificial layer. At least one more sacrificial layer 522 is deposited on top of the actuator electrode 303 and on top of the stops 506. The stops 506 can be on the same level as the actuation electrode 303, below the actuation electrode 303, or above. The difference between FIG. 7A, FIG. 7B, and FIG. 7C is that the part of the cantilever 501 that comes into contact with the stops 506 is underneath the cantilever 501. During processing, for FIG. 7C, the sacrificial layers 521 (for example, PECVD oxide) between the cantilever and actuation electrode is etched in such a way as to create “holes” in the area where stops 506 are located, which will be filled in by the cantilever metal 501 creating “bumps”. Another sacrificial layer 522 is deposited before the cantilever metal 501, as a release layer to isolate cantilever 501 from both actuation electrode 303 and stops 506. The thickness of sacrificial layer 521 determines the air gap between cantilever 501 and actuation electrode 303. In all examples stiction can be further reduced by electrically isolating the stops 506 from the actuation electrode 303.

Another process option, which allows providing different gaps and between cantilever and stops and between cantilever and actuator electrode, is related to using a combination of geometrical shape of the stops and deposition processes that results in a different thickness of sacrificial layer deposited on top of the stops and on top of actuator electrode. For example, if stops have a shape of narrow ridges (as it is shown in FIG. 5A-5C), a spin-on material can be used as a sacrificial layer and this a layer can be deposited on wafers by spinning. In that case thickness of the spin-on material on top of stops 306 is expected to be smaller than its thickness on top of actuator electrode 303. Cantilever material can be deposited on top of this sacrificial layer. After etching off the sacrificial layer, depth of the air gap 319 between cantilever 301 and stops 306 is expected to be smaller than depth of the air gap 309 between cantilever 301 and actuator electrode 303.

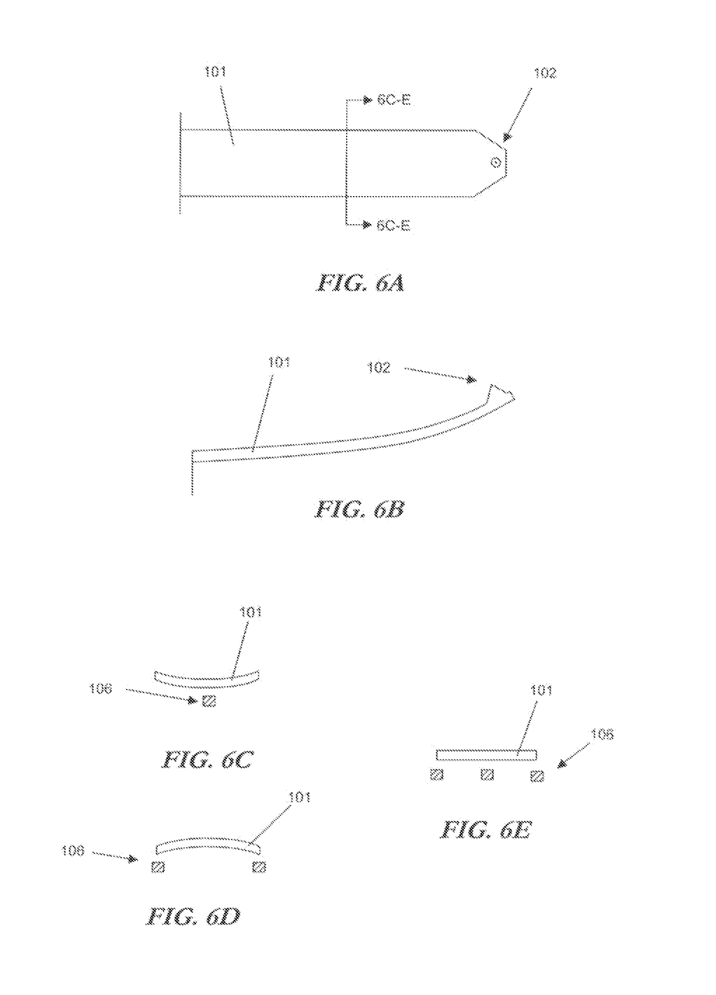

After release, cantilevers are bent out of the surface of the wafer due to a built-in stress gradient as it is illustrated in FIGS. 6A and 6B for a rectangular cantilever 101 with a probe contact tip 102. Besides that, cantilever may have bending in the plane perpendicular to its longitudinal axis. Depending on process parameters, shape of the released cantilever 101 in cross-sections perpendicular to its longitudinal axis can be different. Some possible shapes are shown in FIGS. 6C, 6D and 6E. In order to prevent contact between cantilever 101 and actuator electrode (not shown in FIG. 6) stops 106 can be positioned under the area of the cantilever, (e.g. central part or periphery) that is closer to the actuator electrode due to bending of the cantilever 101 in cross-sections perpendicular to its longitudinal axis. If bending of cantilevers 101 in the cross-sections perpendicular to its longitudinal axis is relatively small then contact between cantilever and the actuator electrode may occur in different areas. Some cantilevers will be contacting the actuator electrode in the central area of the cross-section, while some other cantilevers will make this contact in the peripheral areas. Designs using stops 106 located both under the central part and under periphery of cantilevers 101, as shown in FIG. 6E, can be preferable, because these designs protect the cantilever beam from the direct contact with the actuator electrode regardless of the curvature of the cantilever beam in cross-sections perpendicular to its longitudinal axis.

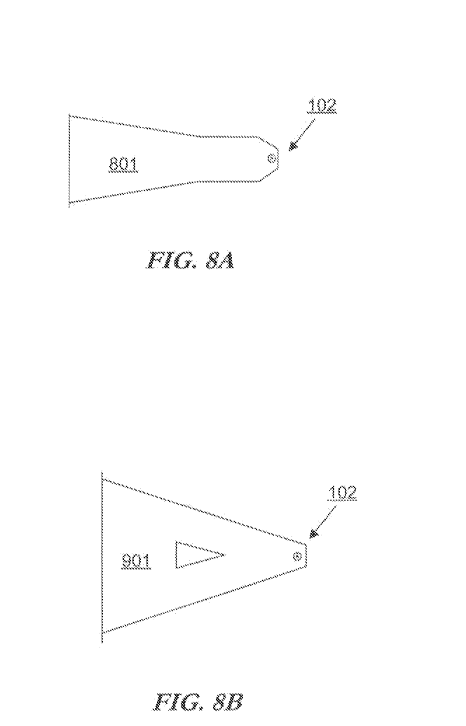

A force Fₑₗ provided by the electrostatic actuator formed by the electrodes 101,103 is directly proportional to the overlapping area A of the electrodes 101,103 and the squared actuation voltage V applied between the electrodes 101,103, and inversely proportional to the squared gap d between the electrodes 101,103 (i.e. Fₑₗ˜A·U²/d²). The maximum voltage that can be used for actuation can be determined either by a voltage supplied to the probe storage device or by an output voltage of special circuits used to increase the maximum voltage available for actuation (e.g. voltage multiplication circuits). Voltage multiplication circuits are often used in devices utilizing low-voltage supply (e.g. handheld devices, battery-operated devices) in order to generate internally voltages, which are higher than the voltage supply. Operating electrostatic actuators at low voltages allows voltage multiplication circuits to be eliminated. The electrostatic force Fₑₗ is increased by decreasing the gap d between the cantilever 101 and the actuator electrode 103 and increasing the overlapping area A of the electrodes 101,103. Referring to FIGS. 8A and 8B, the overlap area A can be increased by increasing the width of the straight bar cantilever 801 of FIG. 3A or filling the hole between legs of the chevron cantilever 901 of FIG. 3B. An increase in overlapping area A also makes the cantilevers 801,901 mechanically stronger. Increased tip force can cause faster wear of one or both of the contact probe tips and the memory media. It can therefore be desirable to compensate tip force increase by one or both of decreasing thickness of the cantilever and increasing cantilever length. Cantilever stiffness is proportional to a cube of its thickness and inversely proportional to a cube of its length. However, cantilever stiffness is a linear function of its width for the straight bar geometry. Therefore, an increase in the overlapping area A can be compensated by relatively small adjustments of cantilever length and thickness. This allows increasing the electrostatic force Fₑₗ without changing the bending stiffness of the cantilever and without changing the tip force, which electrostatic force Fₑₗ should overcome.

Actuator for Control of Lateral Position of Contact Probe Tips

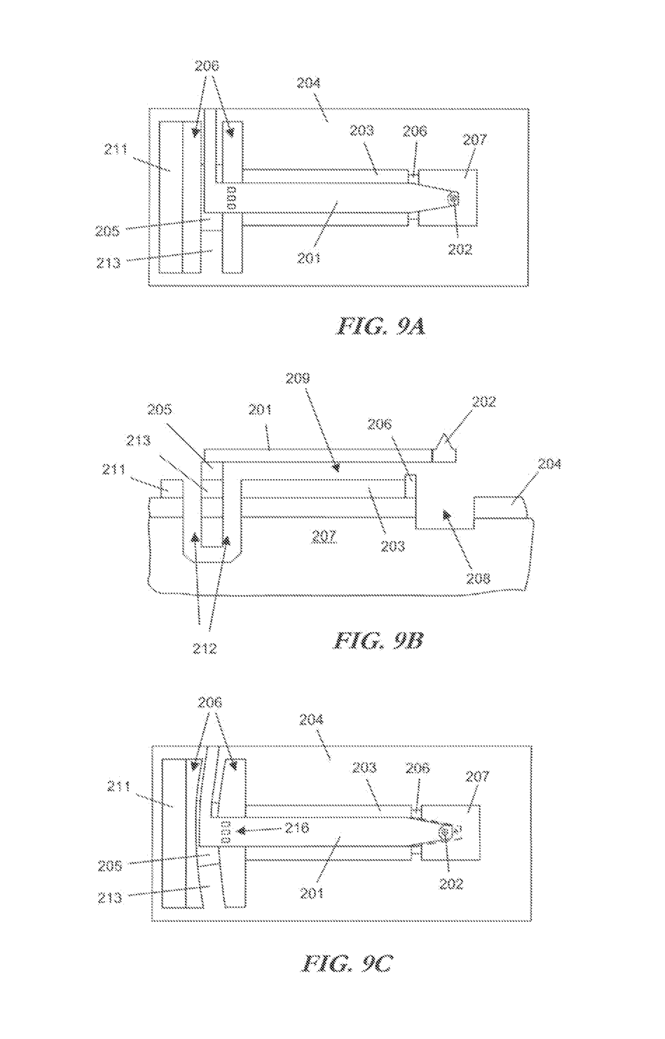

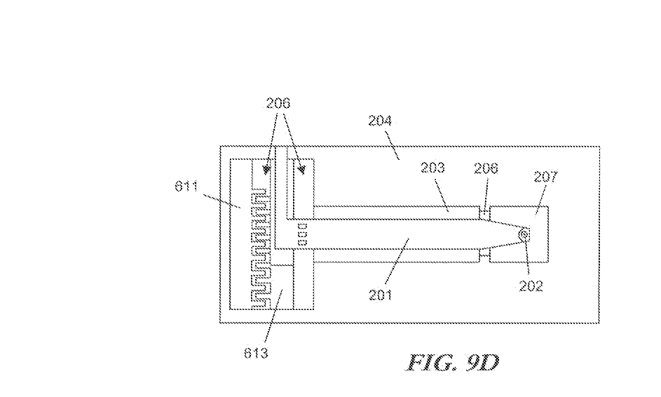

An embodiment of an actuator for fine control of the lateral positions of contact probe tips in accordance with the present invention is shown in FIGS. 9A-9C. Preferably, such an actuator can be used to adjust position of the contact probe tips, for example within 1 to 2 tracks. Assuming a pitch between tracks in the range 30 nm to 50 nm, contact probe tip displacement provided by such an actuator could be in the range of 60 nm to 100 nm. In an embodiment, fine control of the lateral position of a contact probe tip can be used to compensate for shifts between contact probe tips, for example as caused by thermal drift, variation of the gap between plates of the probe storage device, and variation of cross-track deflection of the tips due to variations in cantilever stiffness and friction force at tip-media stack interface. In such embodiments, a control loop for adjusting the lateral position can be independent of servo control and can provide alignment of a group of tips by both initial alignment (i.e. calibration) and tracking environmental conditions. Alternatively, fine control of the lateral position of a contact probe tip can compensate for some other shift between contact probe tips, for example variation in distances between contact probe tips created during manufacturing. This shift also can be compensated for a group of tips during an initial alignment step.

Referring to FIGS. 9A-9D, the actuator includes a flexible structure 205, for example a beam suspended over a cavity 212 and connected to a substrate 207 in one or more areas. A cantilever 201 having a contact probe tip 202 extending from the distal end of the cantilever 201, is connected with the flexible structure 205 at a proximal end of the cantilever 201. The actuator applies lateral force to the flexible structure 205, causing bending of the flexible structure 205 in the plane of the substrate 207 and corresponding lateral displacement of the tip 202. Electrostatic actuation can be used to deflect the flexible structure 205 from a neutral position. In such an embodiment, an electrode 213 comprising a metal is formed on the flexible structure 205. A second electrode 211 is disposed over the substrate 207. Both electrodes 211,213 can extend along the length of the flexible structure 205. When voltage is applied between the electrodes 211,213, an electrostatic force attracts the electrodes 211,213 to each other to cause lateral bending of the flexible structure 205 and corresponding deflection of the contact probe tip 202. Alternatively, electrostatic actuator with comb-shaped electrodes 611,613 shown in FIG. 9D can be used in order to increase electrostatic force and allow actuation at low voltage.

The cavity 212 under the flexible structure 205 can be formed by etching trenches 206 adjacent to the flexible structure 205 at first and then undercutting the flexible structure 205. Openings 216 in the cantilever 201 can be implemented in order to simplify undercutting of the flexible structure under the proximal end of the cantilever 201. Initial etching of the trenches can be done, for example, using reactive ion etching (RIE) process, which allows making profiles with almost vertical side walls. Undercutting of the flexible structure 205 and forming cavity 212 can be done using either anisotropic or isotropic etching. These process steps can be integrated with the discussed above mircomachining steps for forming contact probe tips 202 with reinforcing structures (not shown in FIGS. 9A-9D).

In still other embodiments, different actuation methods can be employed for lateral actuation of the flexible structure 205, including piezoelectric, electromagnetic, thermal, and electrostatic. For example, in an embodiment, where a piezoelectric actuator is used a piezoelectric material can be deposited on a side wall of the flexible structure 205. Applying a voltage to the piezoelectric material can cause the flexible structure 205 to bend and the contact probe tip 202 to move laterally. Alternatively, where an electromagnetic actuator is used a magnetic field can be applied perpendicular to the substrate 207 while current flows along the flexible structure 205. A Lorentz force acts on the flexible structure 205 in the plane of the substrate 207 in a direction perpendicular to the flexible structure 205, causing the flexible structure 205 to bend resulting in lateral displacement of the contact probe tip 202. Direction of the tip deflection can be changed by changing the direction of the current.

In still another embodiment, thermal actuation of the flexible structure 205 can result where current is passed through a conductor or semi-conductor disposed along the flexible structure 205 so that heating occurs, causing the flexible structure 205 to deflect and the contact probe tip 202 to be displaced laterally. In order to define the preferable direction of the flexible structure 205 deflection, the flexible structure 205 can be shaped as an arc. Thermal actuator can consume low power because very small overheating of the arc-shaped flexible structure 205 is enough for 100 nm deflection of the contact probe tip 202. Thermal actuator provides unidirectional motion of the contact probe tip 202.

The foregoing description of the present invention have been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A system for storing data, the system comprising:
a memory media;
a platform;
a cantilever connected with the platform;
a tip extending from the cantilever;
an electrostatic actuator including a first electrode disposed on the platform and a second electrode forming at least a portion of the cantilever;
wherein the electrostatic actuator selectively places the tip in contact with the memory media.

2. The system of claim 1, wherein:
during actuation the first electrode is at a first voltage potential and the second electrode is at a second voltage potential;
the second voltage potential is generally constant; and
the first voltage potential is variable.

3. The system of claim 1, wherein:
the cantilever is biased in order to urge the tip toward the memory media; and
the electrostatic actuator generates an attractive force urging the tip away from the memory media.

4. The system of claim 3, wherein the cantilever is biased by a stress gradient.

5. The system of claim 1, wherein the electrostatic actuator generates a repulsive force urging the tip toward the memory media.

6. The system of claim 1, further comprising a stop extending from the platform to define a minimum distance between the first electrode and the second electrode.

7. The system of claim 1, further comprising:
a plurality of cantilevers connected with the platform;
a plurality of tips extending from the plurality of cantilevers; and
wherein at least one of the cantilevers is actuatable independently of the other of the cantilevers.

8. The system of claim 7, wherein each of the plurality of cantilevers is independently actuatable.

9. The system of claim 7, wherein:
when the at least one cantilever is actuated, a tip extending from the at least one cantilever is urged toward the media; and
when the tip contacts the media, the tip is in electrical communication with the media.

10. The system of claim 1, wherein:
the first electrode and the second electrode at least partially overlap; and
the cantilever is shaped so that a protruding portion protrudes such that the first electrode and the second electrode do no contact when the cantilever is urged toward to the platform.

11. A method of accessing a portion of a memory medium using a tip extending from a cantilever associated with a platform, comprising:
positioning the tip over the portion;
adjusting a voltage of a first electrode associated with the platform such that a second electrode operatively associated with the cantilever is urged relative to the first electrode, thereby urging the cantilever relative to the platform so that the tip contacts the portion of the memory medium;
applying a current to the portion of the memory medium.

12. The method of claim 11, wherein the current is applied to the portion of the memory medium such that an indicia is formed.

13. The method of claim 11, wherein the current is applied to the portion of the memory medium such that an indicia is detected.

14. The method of claim 11, wherein:
the cantilever is biased in order to urge the tip toward the portion of the memory medium;
the first electrode is attracted toward the second electrode; and
when the voltage is adjusted, the first electrode is no longer attracted toward the second electrode and the cantilever is urged so that the tip contacts the portion of the memory medium.

15. The method of claim 11, wherein:
when the voltage is adjusted, the first electrode is repelled from the second electrode so that the cantilever is urged such that the tip contacts the portion of the memory medium.
